(19) United States
(12) Patent Application Publication
(10) Pub. No.: US 2011/0074835 A1
(43) Pub. Date: Mar. 31, 2011

(54) DISPLAY MODULE, ELECTRONIC DEVICE USING THE SAME, AND DISPLAY METHOD THEREOF

(76) Inventors: Chun-Min He, Taipei City (TW); Yu-Te Lin, Taipei City (TW); Sin-Shun Wu, Taipei City (TW)

(21) Appl. No.: 12/880,170

(22) Filed: Sep. 13, 2010

(30) Foreign Application Priority Data
Sep. 29, 2009 (TW) 098132871

(51) Int. Cl. G09G 5/10

(52) U.S. Cl. 345/690

(57) ABSTRACT

This invention provides a display module, an electronic device using the same, and a display method thereof. The display module used in the electronic device is used for displaying a status of an electronic element of the electronic device. The display module includes a light guiding unit, a plurality of light emitting units, and a control unit. The light guiding unit has a light incident surface and a light output surface. The light emitting units are disposed adjacent to the light incident surface. The control unit is coupled with the light emitting units and selectively uses one of a plurality of current combinations to control the light emitting units. Light emitted from the light emitting units enters into the light guiding unit from the light incident surface and passes through the light output surface to present a continuous display effect.

### CROSS-REFERENCE TO RELATED APPLICATIONS

This Non-provisional application claims priority under 35 U.S.C. §119(a) on Patent Application No(s). 098132871 filed in Taiwan, Republic of China on Sep. 29, 2009, the entire contents of which are hereby incorporated by reference.

### BACKGROUND OF THE INVENTION

1. Field of the Invention

This invention relates to a display module and, more particularly, to a display module generating corresponding current combinations to control light emitting elements to present a continuous display effect according to a status of an electronic element of an electronic device, an electronic device using the same, and a display method thereof.

2. Description of the Related Art

At present, a plurality of new generation electronic devices, such as common personal computers or notebook computers, can display used space capacity or remaining space capacity of an electronic element (such as a hard disk or a memory) of the electronic device via computer software. The electronic devices can further display a status of the present space capacity via hardware, for example, a display module of the electronic device can display the used/remaining space capacity of the electronic element in a sectioned mode by controlling a light emitting state of a plurality of light emitting diodes.

FIG. 1A is a schematic diagram showing a conventional display module displaying present used/remaining space capacity of an electronic element in a sectioned mode. In FIG. 1A, display areas 10A to 10C are bright and display areas 10D to 10E are not bright. Therefore, the display condition of the display module points out that the used space capacity of the electronic element reaches 60% and the remaining space capacity is about 40%.

FIG. 1B is a schematic diagram showing a light emitting condition of light emitting diodes corresponding to the display areas in FIG. 1A. Please refer to FIG. 1B, light emitting diodes 12A to 12E correspond to the display areas 10A to 10E, respectively. When the used space capacity of the electronic element reaches 60%, the light emitting diodes 12A to 12C will emit light, and the light emitting diodes 12D to 12E won't.

The above conventional sectioned display mode can roughly display the present used/remaining space capacity of the electronic element. However, there are still many disadvantages.

First, one of the light emitting diodes of the conventional display module is disposed corresponding to one of the display areas respectively, therefore, the same number of the light emitting diodes are needed when the display module needs to accurately display a plurality of sections. However, manufacturing cost of the display module greatly increases. For example, the display module displays the remaining/used capacity of the electronic element in ten sections, i.e., the display module includes ten display areas, the display module also needs ten light emitting diodes to achieve the needed sectioned display effect. The more requirements of the preciseness of the display effect, the more light emitting diodes are needed in the display module. Therefore, the manufacturing cost also increases therewith.

In addition, dark areas may be formed between the adjacent bright display areas in the abovementioned method. For example, a dark area D1 is formed between the bright display areas 10A and 10B, and a dark area D2 is formed between the bright display areas 10B and 10C as shown in FIG. 1A. The whole bright display area seems to be not continuous in appearance because the comparison between the bright area and the dark area is so apparent that design aesthetic of the whole design and feeling of users are affected.

### BRIEF SUMMARY OF THE INVENTION

This invention provides a display module, an electronic device using the same, and a display method thereof to improve the prior art.

In one embodiment of the invention, a display module is provided. The display module is used for displaying a status of an electronic element of an electronic device, such as present remaining capacity or used capacity of the electronic element. The display module includes a light guiding unit, a plurality of light emitting units, and a control unit. The light guiding unit has a light incident surface and a light output surface. The light emitting units are disposed adjacent to the light incident surface of the light guiding unit. The control unit is coupled with the light emitting units and selectively uses one of a plurality of current combinations to control the light emitting units. Light emitted from the light emitting units enters into the light guiding unit from the light incident surface and passes through the light output surface to present a continuous display effect.

In another embodiment of the invention, an electronic device including an electronic element and a display module is provided. The display module is used for displaying a status of the electronic element. The display module includes a light guiding unit, a plurality of light emitting units, and a control unit. The light guiding unit has a light incident surface and a light output surface. The light emitting units are disposed adjacent to the light incident surface of the light guiding unit. The control unit is coupled with the light emitting units and selectively uses one of a plurality of current combinations to control the light emitting units. Light emitted from the light emitting units enters into the light guiding unit from the light incident surface and passes through the light output surface to present a continuous display effect.

In another embodiment of the invention, a display method for displaying a status of an electronic element of an electronic device is provided. The display method includes the following steps. First, a display module including a light guiding unit, a plurality of light emitting units, and a control unit is provided. Then, an optical simulating result is generated. Then, the control unit uses one of a plurality of current combinations to control the light emitting units according to the optical simulating result. Finally, light emitted from the light emitting units enters into the light guiding unit to present a continuous display effect.

This invention provides a display module, an electronic device using the same, and a display method thereof for generating a corresponding current combination to control a plurality of light emitting diodes according to a status of an electronic element of the electronic device, thereby presenting a continuous display effect. Since the display module simulates corresponding relation between each of the current combinations and different display effects via optical simulating software, different current mount combinations can be used to control the less light emitting diodes to display present used/remaining space capacity of the electronic element thus to greatly save manufacturing cost of the display module and to effectively improve the disadvantage that the bright display areas of the display module are not continuous in the prior art.

These and other features, aspects, and advantages of the present invention will become better understood with regard to the following description, appended claims, and accompanying drawings.

### BRIEF DESCRIPTION OF THE DRAWINGS

FIG. 1A is a schematic diagram showing a conventional display module displaying present used/remaining space capacity of an electronic element in a sectioned mode;

FIG. 1B is a schematic diagram showing a light emitting condition of light emitting diodes corresponding to display areas in FIG. 1A;

FIG. 2 is a schematic diagram showing a display module according to a first embodiment of the invention;

FIG. 3 is a schematic diagram showing the display module in FIG. 2 receiving a status signal from an electronic element and outputting a current combination to a respective light emitting diode;

FIG. 4A is a functional block diagram showing a control unit in FIG. 3;

FIG. 4B is a diagram showing a lookup table in FIG. 4A;

FIG. 4C is a diagram showing pulse width modulation signals with different pulse widths in FIG. 4A;

FIG. 5A is a functional block diagram showing a control unit in FIG. 3 according to another embodiment of the invention;

FIG. 5B is a functional block diagram showing a logic circuit in FIG. 5A;

FIG. 6 is a flowchart showing a display method according to a third embodiment of the invention; and

FIG. 7 is a flowchart showing a display method according to a fourth embodiment of the invention.

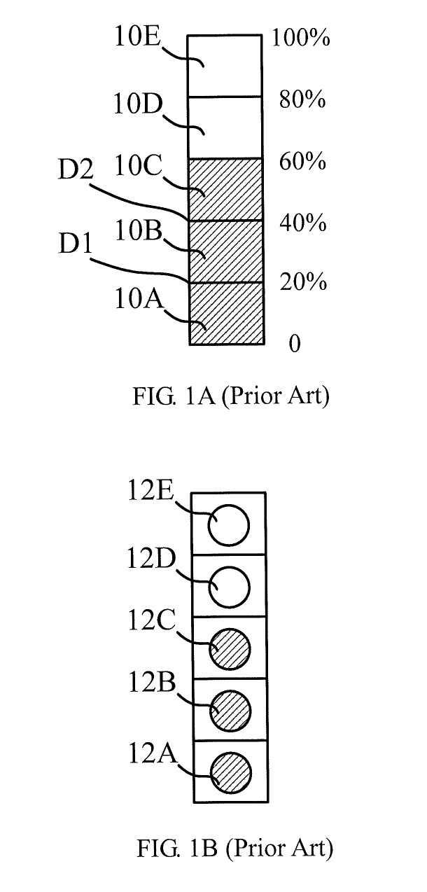

### DETAILED DESCRIPTION OF THE INVENTION

In one first embodiment of this invention, a display module is provided. Actually, the display module is used in an electronic device (such as a personal computer or an industrial computer) for displaying a status of an electronic element (such as a hard disk or a power supply device) of the electronic device, such as present remaining capacity or used capacity of the electronic element. However, the invention is not limited thereto. In addition, the display module can be disposed in the electronic device and be coupled with the electronic element, or it can be externally coupled with the electronic element of the electronic device. However, the invention is not limited thereto.

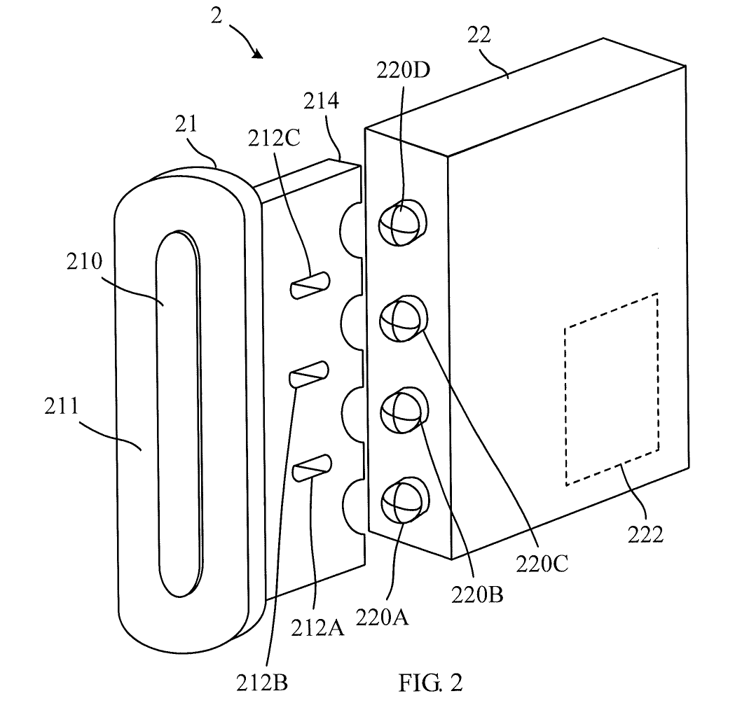

FIG. 2 is a schematic diagram showing a display module according to the first embodiment of the invention. In FIG. 2, a display module 2 includes a light guiding unit 21 and a casing 22. The light guiding unit 21 has a light incident surface 214, a light output surface 211, and a surface treatment layer 210, and the surface treatment layer 210 covers the light output surface 211. In a practical application, the surface treatment layer 210 is not limited to cover the light output surface 211, and it can also be formed on the light output surface 211 via different surface treatment methods such as atomization or texture. In addition, the surface treatment layer 210 can also cover the light incident surface 214 or be formed on the light incident surface 214 via different surface treatment methods, and the surface treatment layer 210 may even be a material of the light guiding unit 21. However, the invention is not limited thereto.

Light emitting diodes 220A to 220D are disposed at the casing 22 and are adjacent to the light incident surface 214 of the light guiding unit 21 thus to allow light emitted from the light emitting diodes 220A to 220D to be transmitted to the light incident surface 214 of the light guiding unit 21 and to enter into the light guiding unit 21 from the light incident surface 214. The control unit 222 is disposed in the casing 22 and is coupled with the light emitting diodes 220A to 220D for controlling whether the light emitting diodes 220A to 220D emit light and strength or brightness of the light. In addition, the light guiding unit 21 also has holes 212A to 212C, and the positions of the holes 212A to 212C correspond to a position between two adjacent light emitting diodes, respectively. However, the invention is not limited thereto.

Actually, the numbers and positions of the light emitting diodes and the holes included by the display module 2 can be determined according to practical needs. However, the invention is not limited thereto. In addition, the light emitting diodes 220A to 220D may be surface-mount device (SMD) light emitting diodes, dual in-line package (DIP) light emitting diodes, or other types of light emitting diodes. The light guiding unit 21 may be a light pipe or other optical elements with a light guiding function, and the light guiding unit 21 may be transparent and made of plastic. However, the invention is not limited thereto.

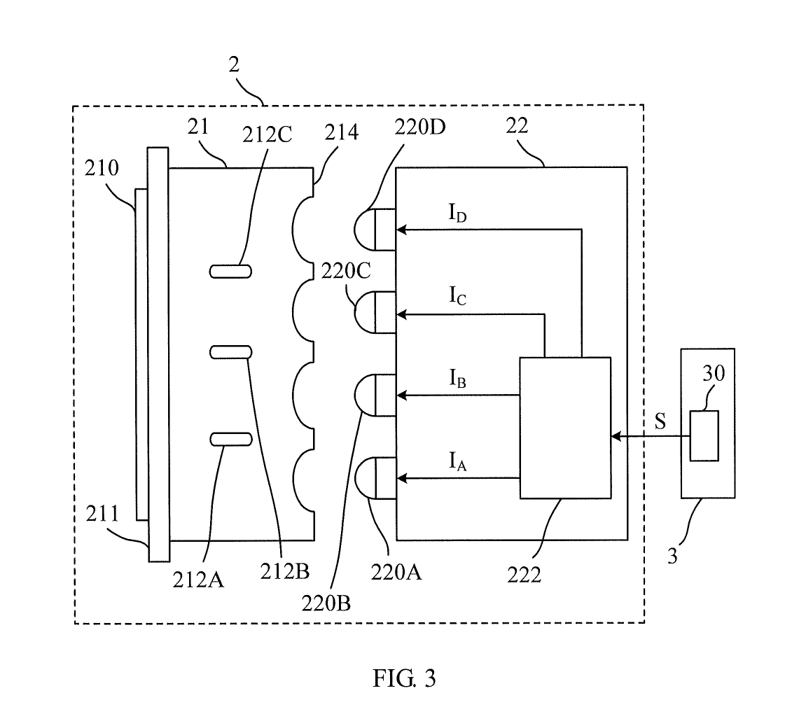

FIG. 3 is a schematic diagram showing the display module 2 in FIG. 2 detecting a status of an electronic element 30 of an electronic device 3 and receiving a status signal S from the electronic element 30 and then outputting corresponding current combinations I_{A} to I_{D} to the light emitting diodes 220A to 220D according to the status signal S. In FIG. 3, the control unit 222 of the display module 2 is coupled with the electronic element 30 of the electronic device 3. After the control unit 222 receives the status signal S from the electronic element 30, the control unit 222 can generate the current combinations I_{A} to I_{D} corresponding to the light emitting diodes 220A to 220D, respectively, according to the status signal S. And then, the control unit 222 output the current combinations I_{A} to I_{D} to the light emitting diodes 220A to 220D, respectively, thereby controlling the light emitting diodes 220A to 220D. The light emitted from the light emitting diodes 220A to 220D can enter into the light guiding unit 21 to present a continuous display effect. That is, display areas presented after the light passes through the light incident surface 214, the light output surface 211, and the surface treatment layer 210 of the light guiding unit 21 are continuous so that the defect of the prior art is effectively improved.

Actually, the display effect correspond to a size of a display area of the light, which is emitted from the light emitting diodes 220A to 220D and passing through the light output surface 211 and the surface treatment layer 210. The display effect can further correspond to strength of display brightness of the light, and the strength of the display brightness corresponds to the current combinations controlling the light emitting diodes 220A to 220D. Therefore, the strength and brightness of the display brightness can be controlled by adjusting the current combinations of the light emitting diodes 220A to 220D in the present invention. In addition, the status signal S can include status information of the electronic element 30, such as present remaining or used capacity information of the electronic element 30 and so on. The electronic element 30 may be an electronic device such as a hard disk, a memory, or a charger and so on. However, the invention is not limited thereto.

Different modes of generating current combinations I_{A} to I_{D} correspondingly controlling the light emitting diodes 220A to 220D by the control unit 222 of the display module 2 according to the status signal S are described herein below.

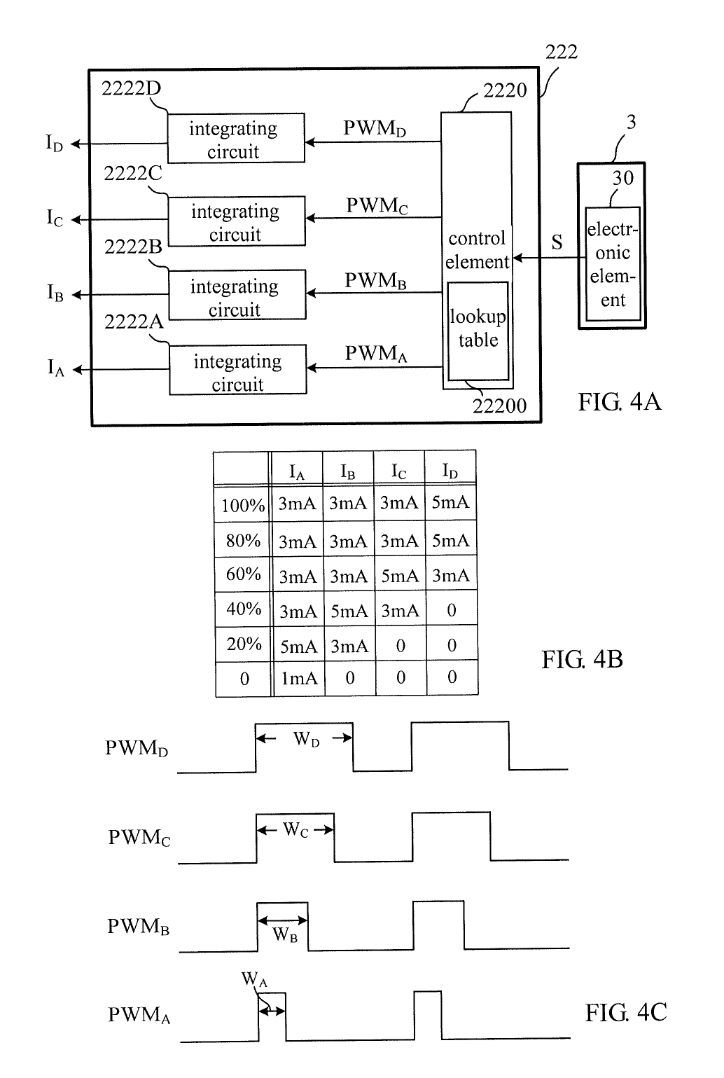

FIG. 4A is a functional block diagram showing a control unit 222. In FIG. 4A, the control unit 222 includes a control element 2220 and integrating circuits 2222A to 2222D. The control element 2220 has a lookup table 22200, and the lookup table 22200 stores an optical simulating result. The integrating circuits 2222A to 2222D are circuits with an integration function, and the types thereof are not limited.

The optical simulating result is obtained via simulation of optical simulating software and represents corresponding relation among the status of the electronic element 30, the current combinations controlling the light emitting diodes, and the different display effects. The optical simulating software may be lighttools, Tracepro, or other software with the optical simulating function. However, the invention is not limited thereto. There are many factors affecting the optical simulating result. Besides the numbers and positions of the light emitting diodes 220A to 220D and the light guiding unit 21, the optical simulating result is also affected by the number and position of the holes 212A to 212C or other factors such as whether the surface treatment layer 210 covers the light incident surface 214 or the light output surface 211.

When the control element 2220 receives the status signal S from the electronic element 30, the control element 2220 can look up the current combinations I_{A} to I_{D} corresponding to the present status of the electronic element 30 in the lookup table 22200.

For example, FIG. 4B is a lookup table of the used space capacity of the electronic element 30 and the current combinations I_{A} to I_{D} after the optical simulation. If the control element 2220 detects that the used space capacity of the electronic element 30 is 40% according to the status signal S, the control element 2220 can obtain that the corresponding current combinations I_{A} to I_{D} are 3 mA, 5 mA, 3 mA, and zero, respectively, from the lookup table 22200.

Back to FIG. 4A, the control element 2220 can output pulse width modulation signals PWM_{A} to PWM_{D} corresponding to the current combinations I_{A} to I_{D} to the integrating circuits 2222A to 2222D after the control element 2220 obtains the value of the current combinations I_{A} to I_{D} from the lookup table. The current combinations I_{A} to I_{D} are then generated through integration of the integrating circuits 2222A to 2222D to control the light emitting diodes 220A to 220D.

Actually, the greater the pulse widths W_{A} to W_{D} of the pulse width modulation signals PWM_{A} to PWM_{D} outputted by the control element 2220 are, the greater corresponding equivalent voltages V_{A} to V_{D} are. When equivalent resistance is fixed, the current combinations I_{A} to I_{D} become greater. Therefore, the corresponding relation between the pulse widths W_{A} to W_{D} and the current combinations I_{A} to I_{D} can also be recorded in the lookup table to allow the control unit 222 to read for use. In FIG. 4C, if a sequence of the current combinations I_{A} to I_{D} is that I_{A}<I_{B}<I_{C}<I_{D}, the sequence of the pulse widths W_{A} to W_{D} of the pulse width modulation signals PWM_{A} to PWM_{D} outputted by the control element 2220 is that W_{A}<W_{B}<W_{C}<W_{D}. Therefore, the control element 2220 can adjust control current of the light emitting diodes 220A to 220D by outputting the pulse width modulation signals with different pulse widths to change brightness of the light emitting diodes 220A to 220D (such as whether the light emitting diodes 220A to 220D emit light or the strength and brightness of the light emitting diodes 220A to 220D) to present different continuous display effects.

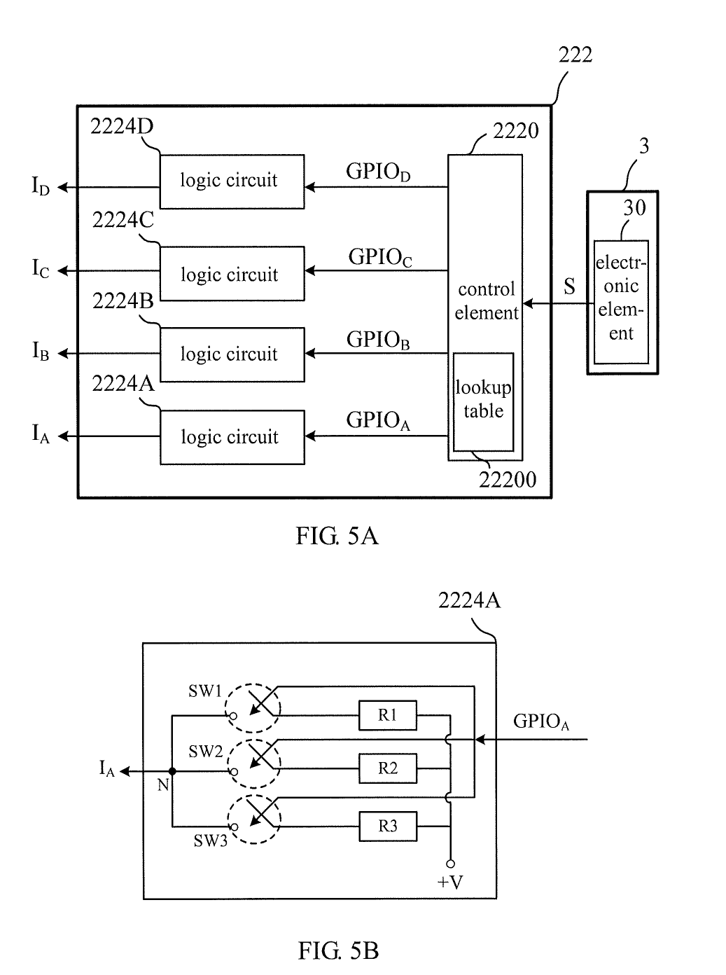

Besides the above generating mode of the current combinations I_{A} to I_{D}, FIG. 5A is a functional block diagram showing the control unit 222 in FIG. 3 according to another embodiment of the invention, i.e., showing another generating mode of the current combinations I_{A} to I_{D}. In FIG. 5A, the control unit 222 includes a control element 2220 and logic circuits 2224A to 2224D. When the control element 2220 receives a status signal S from the electronic element 30, the control element 2220 can look up values of the current combinations I_{A} to I_{D} corresponding to the present status of the electronic element 30 in a lookup table 22200 according to the present status information of the electronic element 30 included by the status signal S.

The control element 2220 outputs corresponding universal input/output signals GPIO_{A} to GPIO_{D} to the logic circuits 2224A to 2224D according to the current combinations I_{A} to I_{D}. And then, the logic circuits 2224A to 2224D output the current combinations I_{A} to I_{D} to the light emitting diodes 220A to 220D to control the light emitting diodes 220A to 220D.

The detailed circuit structure of the logic circuit is shown in FIG. 5B. FIG. 5B is a functional block diagram showing the logic circuit in FIG. 5A, i.e., a circuit diagram showing the logic circuit 2224A according to one embodiment of the invention. In FIG. 5B, the logic circuit 2224A includes switch elements SW1 to SW3 and resistors R1 to R3. Actually, the types and numbers of the switch elements and the resistors included by the logic circuit 2224A can be determined according to practical needs. However, the invention is not limited thereto.

In the embodiment, the universal input/output signal GPIO_{A} outputted from the control element 2220 to the logic circuit 2224A can control the switch elements SW1 to SW3 to be on or off thus to change the equivalent resistance under a specific operating voltage V, thereby adjusting the control current I_{A} finally outputted by the logic circuit 2224A.

For example, if the logic circuit 2224A allows the switch elements SW1 and SW3 to be on and allows the switch element SW2 to be off according to the universal input/output signal GPIO_{A}, that is, only the resistor R2 and a node N are connected and the resistors R1 and R3 and the node N are not connected. Therefore, the control current I_{A} finally outputted by the logic circuit 2224A is (V/R2) when the light emitting diodes 220A to 220D are grounded and the resistance of the switch element SW2 is ignored.

On the other hand, if the logic circuit 2224A allows all the switch elements SW1 to SW3 to be off according to the universal input/output signal GPIO_{A}, the resistors R1 to R3 and the node N are connected. Therefore, the control current I_{A} finally outputted by the logic circuit 2224A is (V/R1)+(V/R2)+(V/R3). At that moment, the control current (V/R1)+(V/R2)+(V/R3) outputted by the logic circuit 2224A is greater than the control current (V/R2). Therefore, at that moment, the brightness of the light emitting diode 220A is higher. Thereby, the brightness of the light emitting diodes 220A to 220D can be changed to present the continuous display effect with different brightness at the surface treatment layer 210.

According to a second embodiment of the invention, an electronic device is provided. In the embodiment, the electronic device includes an electronic element and a display module. The display module is coupled with the electronic element for displaying a status of the electronic element, such as presenting remaining capacity or used capacity of the electronic element (such as a memory or a battery). However, the invention is not limited thereto. The display module includes a light guiding unit, a plurality of light emitting units, and a control unit. The light guiding unit has a light incident surface and a light output surface. The light emitting units are disposed adjacent to the light incident surface of the light guiding unit. The control unit selectively uses one of a plurality of current combinations to control the light emitting units. Light emitted from the light emitting units enters into the light guiding unit from the light incident surface and passes through the light output surface to present a continuous display effect. Detailed operation of the electronic device and the display module in this embodiment are the same as that in the first embodiment. Therefore, it is not described for a concise purpose herein.

According to a third embodiment of the invention, a display method is provided. In a practical application, the display method is used for displaying a status of an electronic element of an electronic device, such as presenting remaining capacity or used capacity of the electronic element. However, the invention is not limited thereto.

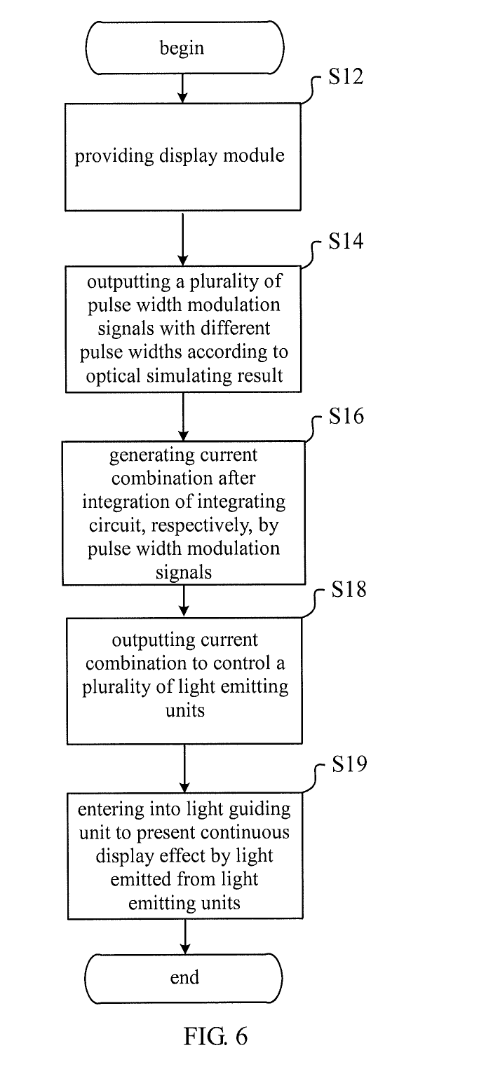

FIG. 6 is a flowchart showing a display method. In FIG. 6, first step S12 is performed. A display module is provided, and the display module includes a light guiding unit, a plurality of light emitting units, and a control unit.

Step S14 is then performed. According to an optical simulating result, a plurality of pulse width modulation signals with different pulse widths is outputted. The optical simulating result can include corresponding relation among the status of the electronic element, current combinations, and different display effects. The optical simulating result can be obtained by simulation via optical simulating software. However, the invention is not limited thereto.

In step S16, the pulse width modulation signals generate a current combination through integration of an integrating circuit, respectively. The detailed operation of step S14 and step S16 can refer to FIG. 4A to FIG. 4C and description thereof. Therefore, it is not described for a concise purpose herein.

Afterwards, step S18 is performed. The current combination is outputted to control the light emitting units to emit light. In step S19, light, which is emitted from the light emitting units, enters into the light guiding unit thus to present a continuous display effect. Actually, the light guiding unit has a light incident surface, a light output surface, and a surface treatment layer. The light, which is emitted from the light emitting unit, enters into the light guiding unit from the light incident surface and passes through the light output surface and the surface treatment layer to present the continuous display effect. In addition, the display effect may be related to a size of a display area of the light and strength of display brightness. However, the invention is not limited thereto.

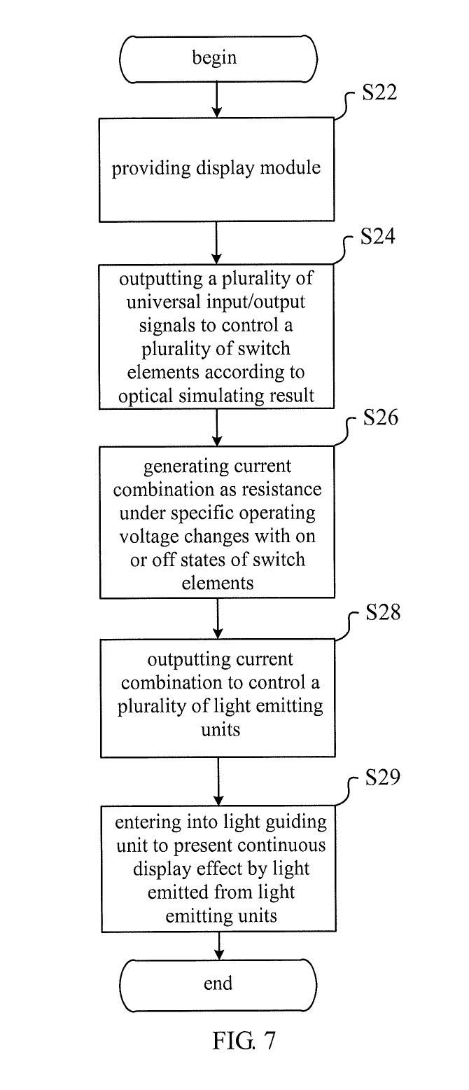

According to a fourth embodiment of the invention, a display method is also provided. In a practical application, the display method is used for displaying a status of an electronic element of an electronic device, such as presenting remaining capacity or used capacity of the electronic element. However, the invention is not limited thereto. FIG. 7 is a flowchart showing the display method. In FIG. 7, first, step S22 is performed. A display module is provided, and the display module includes a light guiding unit, a plurality of light emitting units, and a control unit.

Then, step S24 is performed. According to an optical simulating result, a plurality of universal input/output signals are outputted to control a plurality of switch elements to be on or off. Actually, the optical simulating result may include corresponding relation among the status of the electronic element, current combinations, and different display effects. The optical simulating result can be obtained by simulation via optical simulating software. However, the invention is not limited thereto.

Then, in step S26, under a specific operating voltage, the resistance changes with the on or off states of the switch elements thus to generate a current combination. The detailed description of step S24 and step S26 can refer to FIG. 5A and FIG. 5B and related description. Therefore, it is not described for a concise purpose herein.

Then, step S28 is performed. The current combination is outputted to control the light emitting units to emit light. In step S29, light emitted from the light emitting units enters into the light guiding unit to present a continuous display effect. Actually, the light guiding unit has a light incident surface, a light output surface, and a surface treatment layer. The light emitted from the light emitting units can enter into the light guiding unit from the light incident surface and passes through the light output surface and the surface treatment layer to present the continuous display effect. In addition, the display effect can be related to a size of a display area of the light emitted from the light emitting units at the display module and strength of display brightness. However, the invention is not limited thereto.

compared with the prior art, the present invention discloses the display module which can generate the corresponding current combination to control the light emitting diodes to emit light or to control strength or brightness of the light emitting diodes according to the status of the electronic element of the electronic device so that the continuous display effect will be presented. Furthermore, the corresponding relation between the current combinations and the different display effects has been simulated in an optical simulating mode, the less light emitting diodes would been need now. On the other words, the display module can control less light emitting diodes just via different current combinations to display the present used/remaining space capacity of the electronic element. Manufacturing cost of the display module in the present invention is greatly saved and the disadvantages that the bright display areas are not continuous in the prior art are also effectively improved. Thus, the design aesthetic of the whole design can be improved further to improve feeling of users.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display module used in an electronic device for displaying a status of an electronic element of the electronic device, the display module comprising:
a light guiding unit having a light incident surface and a light output surface;
a plurality of light emitting units disposed adjacent to the light incident surface of the light guiding unit; and
a control unit coupled with the light emitting units and selectively using one of a plurality of current combinations to control the light emitting units, wherein light emitted from the light emitting units enters into the light guiding unit from the light incident surface and passes through the light output surface to present a continuous display effect.

2. The display module according to claim 1, wherein the control unit is coupled with the electronic element to detect the status and to control the light emitting units according to the status.

3. The display module according to claim 1, wherein the control unit uses one of the current combinations to control the light emitting units according to an optical simulating result, and the optical simulating result includes corresponding relation among the status of the electronic element, the current combinations, and the display effect.

4. The display module according to claim 1, wherein the status corresponds to remaining capacity or used capacity of the electronic element.

5. The display module according to claim 1, wherein the display effect corresponds to a size of a display area of the light emitted from the light emitting units and passing through the light output surface.

6. The display module according to claim 1, wherein the display effect corresponds to strength of display brightness of the light emitted from the light emitting units and passing through the light output surface, and the strength of the display brightness corresponds to one of the current combinations.

7. The display module according to claim 1, wherein the control unit outputs a plurality of pulse width modulation signals with different pulse widths and generates the current combinations through integration of an integrating circuit.

8. The display module according to claim 1, wherein the control unit comprises a plurality of switches, and the control unit controls the switches to be on or off thus to adjust resistance under a specific operating voltage to generate the current combinations.

9. The display module according to claim 1, wherein the light emitting units are surface-mount device (SMD) light emitting diodes or dual in-line package (DIP) light emitting diodes.

10. The display module according to claim 1, wherein the light guiding unit further comprises a surface treatment layer formed on the light output surface or the light incident surface.

11. The display module according to claim 10, wherein the surface treatment layer is an atomization treatment layer or a texture treatment layer.

12. The display module according to claim 1, wherein the light guiding unit is a light pipe.

13. The display module according to claim 1, wherein the light guiding unit is transparent and made of plastic.

14. The display module according to claim 1, wherein the light guiding unit has at least one hole corresponding to the light emitting units.

15. An electronic device comprising:
an electronic element; and
a display module coupled with the electronic element for displaying a status of the electronic element, the display module including:
a light guiding unit having a light incident surface and a light output surface;
a plurality of light emitting units disposed adjacent to the light incident surface of the light guiding unit; and
a control unit coupled with the light emitting units and selectively using one of a plurality of current combinations to control the light emitting units, wherein light emitted from the light emitting units enters into the light guiding unit from the light incident surface and passes through the light output surface to present a continuous display effect.

16. The electronic device according to claim 15, wherein the control unit detects the status of the electronic element and controls the light emitting units according to the status.

17. The electronic device according to claim 15, wherein the status corresponds to remaining capacity or used capacity of the electronic element.

18. The electronic device according to claim 15, wherein the control unit uses one of the current combinations to control the light emitting units according to an optical simulating result, and the optical simulating result includes corresponding relation among the status of the electronic element, the current combinations, and the display effect.

19. The electronic device according to claim 15, wherein the display effect corresponds to a size of a display area of the light emitted from the light emitting units and passing through the light output surface.

20. The electronic device according to claim 15, wherein the display effect corresponds to strength of display brightness of the light emitted from the light emitting units and passing through the light output surface, and the strength of the display brightness corresponds to one of the current combinations.

21. The electronic device according to claim 15, wherein the control unit outputs a plurality of pulse width modulation signals with different pulse widths and generates the current combinations through integration of an integrating circuit.

22. The electronic device according to claim 15, wherein the control unit comprises a plurality of switch elements, and the control unit controls the switch elements to be on or off thus to adjust resistance under a specific operating voltage to generate the current combinations.

23. The electronic device according to claim 15, wherein the light guiding unit further comprises a surface treatment layer formed on the light output surface or the light incident surface.

24. The electronic device according to claim 15, wherein the electronic element is a storage unit or a power supply unit.

25. A display method for displaying a status of an electronic element of an electronic device, the display method comprising the following steps of:
providing a display module including a light guiding unit, a plurality of light emitting units, and a control unit;
using one of a plurality of current combinations to control the light emitting units according to an optical simulating result by the control unit; and
presenting a continuous display effect by light emitted from the light emitting units and entered into the light guiding unit.

26. The display method according to claim 25, wherein the optical simulating result is obtained by performing optical simulating software.

27. The display method according to claim 25, wherein the optical simulating result comprises corresponding relation among the status of the electronic element, the current combinations, and the display effect.

28. The display method according to claim 25, wherein the status corresponds to remaining capacity or used capacity of the electronic element.

29. The display method according to claim 25, wherein the light guiding unit has a light incident surface and a light output surface, and the light emitted from the light emitting units enters into the light guiding unit from the light incident surface and passes through the light output surface to present the display effect.

30. The display method according to claim 29, wherein the display effect corresponds to a size of a display area of the light emitted from the light emitting units and passing through the light output surface.

31. The display method according to claim 29, wherein the display effect corresponds to strength of display brightness of the light emitted from the light emitting units and passing through the light output surface, and the strength of the display brightness corresponds to one of the current combinations.

32. The display method according to claim 29, wherein the light guiding unit further comprises a surface treatment layer formed on the light output surface or the light incident surface.

33. The display method according to claim 25, wherein the control unit outputs a plurality of pulse width modulation signals with different pulse widths and generates the current combinations through integration of an integrating circuit.

34. The display method according to claim 25, wherein the control unit comprises a plurality of switch elements, and the control unit controls the switch elements to be on or off thus to adjust resistance under a specific operating voltage to generate the current combinations.
